(19) United States
(12) Patent Application Publication
(10) Pub. No.: US 2019/0264696 A1
(43) Pub. Date: Aug. 29, 2019

(54) CENTRIFUGAL FAN

(71) Applicant: Nidec Corporation, Kyoto (JP)

(72) Inventors: Tomoyuki TSUKAMOTO, Kyoto (JP); Kazuhiko FUKUSHIMA, Kyoto (JP)

(21) Appl. No.: 16/267,572

(22) Filed: Feb. 5, 2019

(30) Foreign Application Priority Data
Feb. 26, 2018 (JP) 2018-031908

(51) Int. Cl. F04D 17/16; F04D 25/06; F04D 29/28; F04D 29/62; F04D 29/42; F04D 29/66

(52) U.S. Cl. CPC F04D 17/16; F04D 25/0606; F04D 29/281; F04D 29/288; F04D 29/624; F05B 2280/6012; F04D 29/666; F05B 2240/301; F05B 2240/14; F05B 2230/232; F05B 2260/96; F04D 29/4226

(57) ABSTRACT

A centrifugal fan includes a motor, a support body, first and second rotating bodies, and a housing. The motor includes a rotor hub. The support body is fixed to and rotates together with the rotor hub. The first and second rotating bodies are continuous porous bodies and are different in material than the support body. The first rotating body is located on an axially upper surface of the support body. The second rotating body is located on an axially lower surface of the support body. The housing accommodates the first and second rotating bodies, the support body, and the motor. The housing includes a first air inlet and an air outlet. A radially inner surface of the first rotating body opposes a radially outer surface of the rotor hub with a gap interposed therebetween.

### CROSS REFERENCE TO RELATED APPLICATIONS

This application claims the benefit of priority to Japanese Patent Application No. 2018-031908 filed on Feb. 26, 2018. The entire contents of this application are hereby incorporated herein by reference.

### BACKGROUND OF THE INVENTION

### 1. Field of the Invention

The present disclosure relates to a centrifugal fan.

### 2. Description of the Related Art

General centrifugal fans rotate a plurality of blades to convert an incoming airflow parallel to the axial direction into a radial airflow and discharge the radial airflow. The centrifugal fan is mounted, for example, as a cooling fan, to an electronic device such as a notebook personal computer. The centrifugal fan to be mounted to the electronic device such as the notebook personal computer is required to have noise reduction.

In general centrifugal fans, however, turbulent flow which causes noise is generated in the vicinity of a radially distal end of each blade since the plurality of blades rotate. Specifically, the rotation of the plurality of blades generates a pressure difference in the circumferential direction between a front surface of each blade in the traveling direction and a rear surface in the traveling direction. As a result, an airflow flowing from the front surface in the traveling direction through the radially distal end of the blade toward the rear surface in the traveling direction is generated, and this airflow causes the turbulent flow.

### SUMMARY OF THE INVENTION

A centrifugal fan according to an exemplary embodiment of the present invention includes a motor, a support body, a first rotating body, a second rotating body, and a housing. The motor includes a rotor hub that rotates around a central axis extending up and down. The support body is fixed to the rotor hub and rotates together with the rotor hub. The first rotating body and the second rotating body are different in material from the support body. The first rotating body and the second rotating body are continuous porous bodies. The housing accommodates the first rotating body, the second rotating body, the support body, and the motor. The housing includes a first air inlet open in an axial direction and at least one air outlet open in a radial direction. The first rotating body is located on an axially upper surface of the support body, and the second rotating body is located on an axially lower surface of the support body. A radially inner surface of the first rotating body opposes a radially outer surface of the rotor hub with a gap interposed therebetween.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1A is a plan view of a centrifugal fan according to a first exemplary embodiment of the present disclosure.

FIG. 1B is a plan view illustrating the inside of the centrifugal fan according to the first exemplary embodiment of the present disclosure.

FIG. 2 is a side view illustrating a portion of the centrifugal fan according to the first exemplary embodiment of the present disclosure.

FIG. 3 is a perspective view illustrating the inside of the centrifugal fan according to the first exemplary embodiment of the present disclosure.

FIG. 4 is a cross-sectional view illustrating a portion of the centrifugal fan according to the first exemplary embodiment of the present disclosure.

FIG. 5 is a view illustrating a first modified example of a first rotating body and a second rotating body according to the first exemplary embodiment of the present disclosure.

FIG. 6 is a view illustrating a second modified example of the first rotating body and the second rotating body according to the first exemplary embodiment of the present disclosure.

FIG. 7 is a view illustrating a third modified example of the first rotating body and the second rotating body according to the first exemplary embodiment of the present disclosure.

FIG. 8 is a cross-sectional view illustrating a portion of a centrifugal fan according to a second exemplary embodiment of the present disclosure.

FIG. 9 is a cross-sectional view of a centrifugal fan according to a third exemplary embodiment of the present disclosure.

FIG. 10 is a plan view of a centrifugal fan according to a fourth exemplary embodiment of the present disclosure.

FIG. 11 is a cross-sectional view illustrating a portion of a centrifugal fan according to a fourth exemplary embodiment of the present disclosure.

FIG. 12 is a bottom view of the centrifugal fan according to the fourth exemplary embodiment of the present disclosure.

### DETAILED DESCRIPTION OF THE PREFERRED EMBODIMENTS

Hereinafter, exemplary embodiments of the present disclosure will be described with reference to the drawings. However, the present invention is not limited to the following embodiments. In the drawings, the same or corresponding parts will be denoted by the same reference signs, and descriptions thereof will not be repeated. Further, points for which descriptions overlap each other will be sometimes omitted as appropriate.

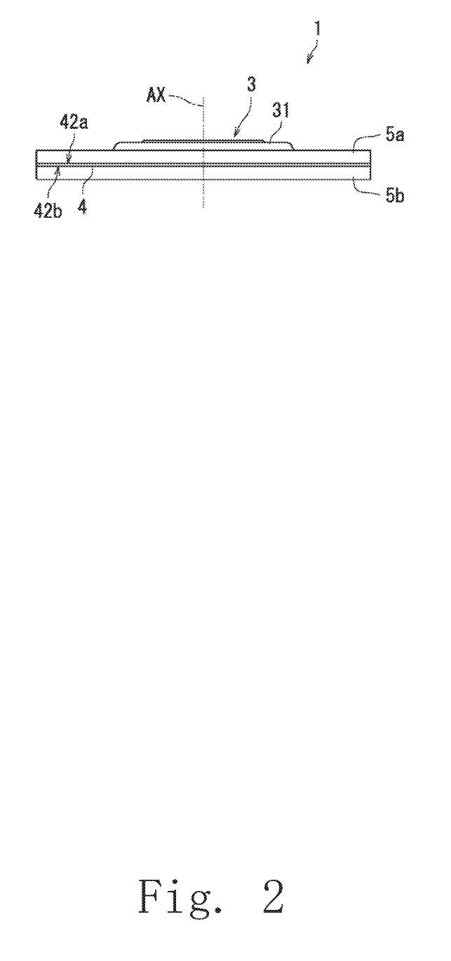

In the present specification, a direction in which a central axis AX (see FIG. 2) of a motor 3 extends will be described as an up-down direction for the sake of convenience. However, the up-down direction is defined for convenience of the description, and there is no intention that the direction of the central axis AX coincides with the vertical direction. In the present specification, a direction parallel to the central axis AX of the motor 3 will be referred to as an “axial direction”, a radial direction and a circumferential direction around the central axis AX of the motor 3 will be referred to as a “radial direction” and a “circumferential direction”. However, in practicality, there is no intention to limit the orientation during use of the centrifugal fan according to the present disclosure to such definitions. Incidentally, the “parallel direction” includes a substantially parallel direction.

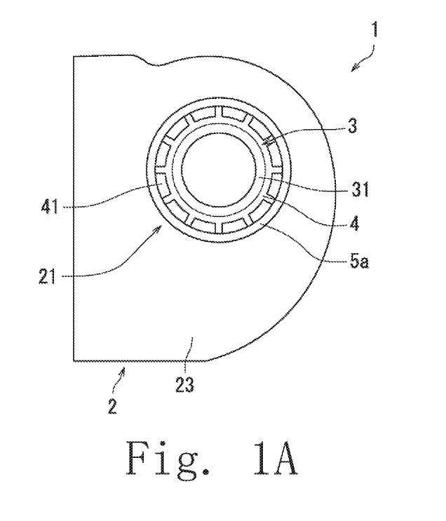

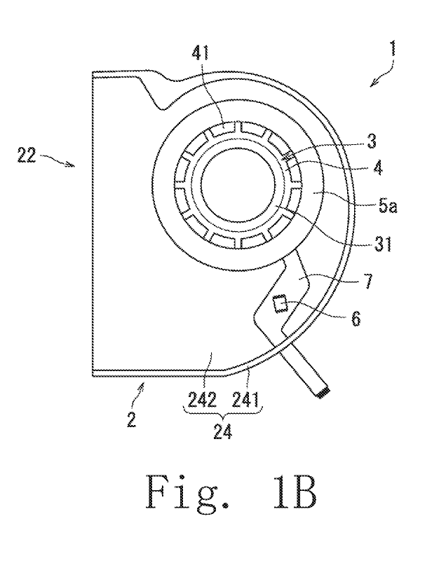

FIG. 1A is a plan view illustrating a centrifugal fan 1 according to a first embodiment. As illustrated in FIG. 1A, the centrifugal fan 1 includes a housing 2, a motor 3, a support body 4, and an annular first rotating body 5a. The housing 2 has an air inlet 21 that is open in the axial direction. Specifically, the housing 2 has a cover member 23, and the cover member 23 has the air inlet 21. In the present embodiment, the cover member 23 forms an upper wall portion of the housing 2.

FIG. 1B is a plan view illustrating the inside of the centrifugal fan 1 according to the first embodiment. Specifically, FIG. 1B illustrates the centrifugal fan 1 from which the cover member 23 illustrated in FIG. 1A has been removed. As illustrated in FIGS. 1A and 1B, the housing 2 accommodates the motor 3, the support body 4, and the first rotating body 5a.

As illustrated in FIG. 1B, the housing 2 has an air outlet 22 that is open in a radial direction. Specifically, the housing 2 has a case member 24. The case member 24 is covered with the cover member 23 illustrated in FIG. 1A. The case member 24 has a side wall portion 241, and the side wall portion 241 has an air outlet 22. Further, the case member 24 has a lower wall portion 242. The lower wall portion 242 opposes the cover member 23 illustrated in FIG. 1A in the axial direction.

As illustrated in FIG. 1B, the centrifugal fan 1 further includes a motor driver 6 and a wiring board 7. The motor driver 6 generates a drive signal to d rive the motor 3 based on a control signal transmitted from an external controller. The motor driver 6 is mounted to the wiring board 7. The wiring board 7 receives the control signal transmitted from the external controller and transmits the received control signal to the motor driver 6. Further, the wiring board 7 transmits the drive signal generated by the motor driver 6 to the motor 3. The housing 2 further accommodates the motor driver 6. In the present embodiment, the housing 2 accommodates a part of the wiring board 7.

FIG. 2 is a side view illustrating a part of the centrifugal fan 1 according to the first embodiment. Specifically, FIG. 2 illustrates the motor 3, the support body 4, the first rotating body 5a, and a second rotating body 5b. As illustrated in FIG. 2, the centrifugal fan 1 further includes the second rotating body 5b. The housing 2 described with reference to FIGS. 1A and 1B further accommodates the second rotating body 5b.

The support body 4 has an axially upper surface 42a and an axially lower surface 42b. The axially upper surface 42a is a surface of the support body 4 on the axially upper side, and the axially lower surface 42b is a surface of the support body 4 on the axially lower side. The first rotating body 5a is arranged on the axially upper surface 42a of the support body 4, and the second rotating body 5b is arranged on the axially lower surface 42b of the support body 4.

Next, the motor 3 will be described with reference to FIGS. 1A, 1B, and 2. As illustrated in FIGS. 1A, 1B and 2, the motor 3 has a rotor hub 31. As illustrated in FIG. 2, the rotor hub 31 rotates about the central axis AX.

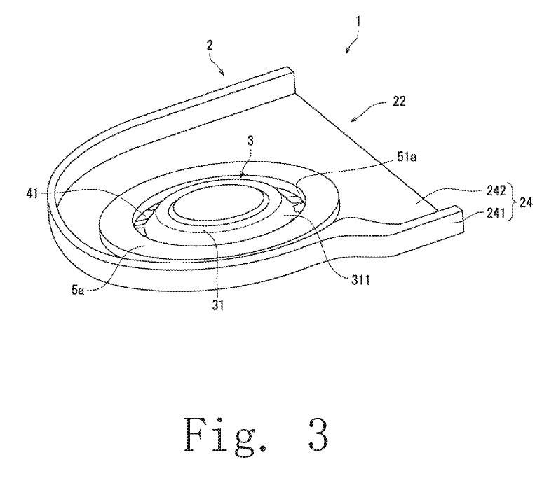

FIG. 3 is a perspective view illustrating the inside of the centrifugal fan 1 according to the first embodiment. Specifically, FIG. 3 illustrates the centrifugal fan 1 from which the cover member 23 illustrated in FIG. 1A has been removed. As illustrated in FIG. 3, the rotor hub 31 has a radially outer surface 311, and the first rotating body 5a has a radially inner surface 51a. The radially inner surface 51a of the first rotating body 5a opposes the radially outer surface 311 of the rotor hub 31 with a gap interposed therebetween.

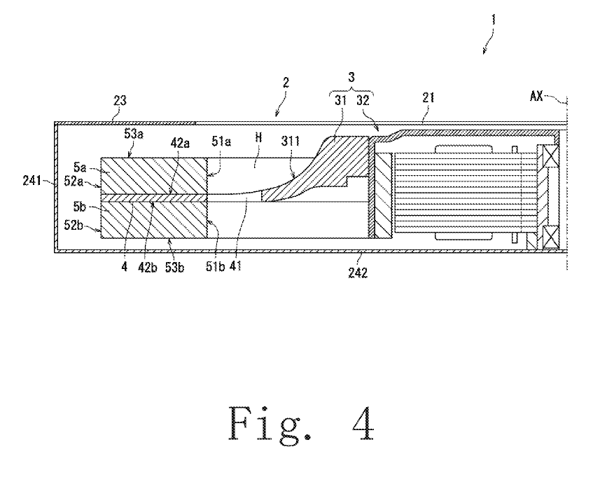

FIG. 4 is a cross-sectional view illustrating a part of the centrifugal fan 1 according to the first embodiment. Specifically, FIG. 4 illustrates cross sections of the housing 2, the motor 3, the support body 4, the first rotating body 5a, and the second rotating body 5b.

As illustrated in FIG. 4, the motor 3 has a motor unit 32. The motor unit 32 rotates the rotor hub 31 in the circumferential direction about the central axis AX. The support body 4 is fixed to the rotor hub 31 and rotates together with the rotor hub 31. Specifically, the support body 4 protrudes in the radial direction from the rotor hub 31. The rotor hub 31 protrudes axially upward from a proximal end portion of the support body 4. The rotor hub 31 and the support body 4 may be integrated or may be separate bodies.

The first rotating body 5a is fixed to the support body 4 and extends in the circumferential direction. A material of the first rotating body 5a is different from a material of the support body 4. The material of the first rotating body 5a is, for example, a continuous porous body such as foamed urethane. The continuous porous body is a material which has a plurality of continuous air holes such that a wall between adjacent air holes is open and through which a fluid such as a gas can pass. For example, the material of the first rotating body 5a may be an open-cell structure. The open-cell structure is a material which has a plurality of continuous air cells (air holes) such that a wall between adjacent air cells is open and through which a fluid such as a gas can pass. The material of the support body 4 is, for example, hard plastic.

The second rotating body 5b has an annular shape similarly to the first rotating body 5a, is fixed to the support body 4, and extends in the circumferential direction. A material of the second rotating body 5b is different from the material of the support body 4 similarly to the first rotating body 5a. The material of the second rotating body 5bb is a continuous porous body similarly to the first rotating body 5a. For example, the material of the second rotating body 5b is an open-cell structure.

As illustrated in FIG. 4, the first rotating body 5a has a radially outer surface 52a and an axially upper surface 53a. The second rotating body 5b has a radially inner surface 51b, a radially outer surface 52b, and an axially lower surface 53b.

The axially upper surface 53a of the first rotating body 5a opposes the cover member 23 in the axial direction with a gap interposed therebetween. The radially outer surface 52a of the first rotating body 5a opposes the side wall portion 241 in the radial direction with a gap interposed therebetween.

The radially outer surface 52b of the second rotating body 5b opposes the side wall portion 241 in the radial direction with a gap interposed therebetween. The axially lower surface 53b of the second rotating body 5b opposes the lower wall portion 242 in the axial direction with a gap interposed therebetween.

Next, the support body 4 will be further described with reference to FIGS. 1A, 1B, 3, and 4. As illustrated in FIGS. 1A, 1B, and 3, the support body 4 has a plurality of through-holes 41. In the present embodiment, the plurality of through-holes 41 is arranged in the circumferential direction. As illustrated in FIG. 4, the through-hole 41 passes through the support body 4 in the axial direction. Further, the through-hole 41 is arranged to be open in a gap (gap H) between the radially inner surface 51a of the first rotating body 5a and the radially outer surface 311 of the rotor hub 31. Incidentally, it is unnecessary to clearly define a boundary between the rotor hub 31 and the support body 4 as long as the rotor hub 31 has the radially outer surface 311 and the support body 4 has the axially upper surface 42a, the axially lower surface 42b, and the plurality of through-holes 41.

Next, an operation of the centrifugal fan 1 will be described with reference to FIGS. 1A, 1B, and 2 to 4. When the rotor hub 31 rotates in the centrifugal fan 1, the support body 4, the first rotating body 5a, and the second rotating body 5b rotate in the circumferential direction about the central axis AX.

When the first rotating body 5a rotates in the circumferential direction, air inside the first rotating body 5a moves to the radially outer surface 52a of the first rotating body 5a by a centrifugal force. The air that has moved to the radially outer surface 52a of the first rotating body 5a is sent to the outside of the first rotating body 5a from the radially outer surface 52a of the first rotating body 5a. Similarly, when the second rotating body 5b rotates in the circumferential direction, air inside the second rotating body 5b moves to the radially outer surface 52b of the second rotating body 5b by the centrifugal force. The air that has moved to the radially outer surface 52b of the second rotating body 5b is sent to the outside of the second rotating body 5b from the radially outer surface 52b of the second rotating body 5b. The air sent from the radially outer surface 52a of the first rotating body 5a to the outside of the first rotating body 5a is sent to the outside from the air outlet 22. Similarly, the air sent from the radially outer surface 52b of the second rotating body 5b to the outside of the second rotating body 5b is sent to the outside from the air outlet 22.

When the air inside the first rotating body 5a is sent to the outside of the first rotating body 5a, the air between the rotor hub 31 and the radially inner surface 51a of the first rotating body 5a is sucked from the radially inner surface 51a of the first rotating body 5a into the inside of the first rotating body 5a. When the air inside the second rotating body 5b is sent to the outside of the second rotating body 5b, the air outside the radially inner surface 51b of the second rotating body 5b is sucked from the radially inner surface 51b of the second rotating body 5b into the inside of the second rotating body 5b. As a result, the air outside the housing 2 is sucked into a space between the rotor hub 31 inside the housing 2 and the radially inner surface 51a of the first rotating body 5a from the air inlet 21. Further, a part of the air sucked between the rotor hub 31 and the radially inner surface 51a of the first rotating body 5a passes through the through-hole 41.

Therefore, when the rotor hub 31 rotates, the air is sucked into the inside of the housing 2 from the air inlet 21, and the air sucked into the interior of the housing 2 is blown to the outside of the housing 2 from the air outlet 22.

When the first rotating body 5a rotates in the circumferential direction, friction is generated between the axially upper surface 53a of the first rotating body 5a and the air. As a result, the air existing in the gap between the axially upper surface 53a of the first rotating body 5a and the cover member 23 moves to the radially outer surface 52a side of the first rotating body 5a. Similarly, when the second rotating body 5b rotates in the circumferential direction, friction is generated between the axially lower surface 53b of the second rotating body 5b and the air. As a result, the air existing in the gap between the axially lower surface 53b of the second rotating body 5b and the lower wall portion 242 moves to the radially outer surface 52b side of the second rotating body 5b. Therefore, airflow (reverse flow) flowing from the gap between the axially upper surface 53a of the first rotating body 5a and the cover member 23 and the gap between the axially lower surface 53b of the second rotating body 5b and the lower wall portion 242 to the air inlet 21 hardly occurs. Accordingly, the efficiency of the centrifugal fan 1 can be improved.

The centrifugal fan 1 according to the first embodiment has been described above with reference to FIGS. 1A, 1B, and 2 to 4. Although all of the through-holes 41 are arranged to be open in the gap H in the present embodiment, a part of each of the through-holes 41 may be arranged to be open in the gap H. Alternatively, the plurality of through-holes 41 may include the through-hole 41 that is entirely open in the gap H and the through-hole 41 that is partially open in the gap H. Alternatively, the plurality of through-holes 41 may include the through-hole 41 that is entirely is covered with the first rotating body 5a and the second rotating body 5b.

According to the present embodiment, noise can be reduced by using the annular rotating body made of the continuous porous body. In other words, it is possible to achieve noise reduction. Specifically, in a centrifugal fan using a rotating body having a plurality of blades, turbulent flow that causes noise is generated due to a pressure difference generated in the vicinity of a radially distal end of each blade. According to the present embodiment, however, since the annular rotating body made of the continuous porous body is rotated, the turbulent flow is less likely to occur as compared with the centrifugal fan that rotates the plurality of blades. Therefore, the noise can be reduced.

According to the present embodiment, the annular rotating body made of the continuous porous body is arranged on both sides of the support body 4. As a result, the amount of air blowing is increased, and a PQ characteristic is improved. Incidentally, the PQ characteristic indicates a relationship between air volume and static pressure at the air inlet 21 and the air outlet 22.

Each of the first rotating body 5a and the second rotating body 5b is thinner than one rotating body having a total thickness of a thickness of the first rotating body 5a in the axial direction and a thickness of the second rotating body 5b in the axial direction. Therefore, even when a soft material such as an open-cell structure is used as each material of the first rotating body 5a and the second rotating body 5b, it is possible to make each thickness of the first rotating body 5a and the second rotating body 5b in the axial direction thin to suppress each deformation amount of the first rotating body 5a and the second rotating body 5b according to the present embodiment. For example, the thickness of the rotating body made of the soft material in the axial direction decreases while extending in the radial direction by a centrifugal force. As the thickness of the rotating body in the axial direction becomes thinner, it is possible to suppress the amount of extension in the radial direction and the amount of decrease of the thickness in the axial direction. Incidentally, the thickness of the first rotating body 5a in the axial direction indicates a distance (length) from the axially upper surface 42a of the support body 4 to the axially upper surface 53a of the first rotating body 5a. The thickness of the second rotating body 5b in the axial direction indicates a distance (length) from the axially lower surface 42b of the support body 4 to the axially lower surface 53b of the second rotating body 5b.

According to the present embodiment, it is possible to make the thickness of the first rotating body 5a in the axial direction thin. Therefore, since the thickness of the rotating body opposing the radially outer surface 311 of the rotor hub 31 can be made thin, the length of the rotor hub 31 in the axial direction can be shortened. Accordingly, it is possible to suppress the deformation of the rotor hub 31 caused by the centrifugal force or the like during the rotation by shortening the length of the rotor hub 31 in the axial direction.

According to the present embodiment, the radially inner surface 51a of the first rotating body 5a opposes the radially outer surface 311 of the rotor hub 31 with the gap H interposed therebetween. Therefore, air easily enters the inside of the first rotating body 5a from the radially inner surface 51a of the first rotating body 5a, and the amount of air blowing of the centrifugal fan 1 increases.

Since the first rotating body 5a and the second rotating body 5b are formed of the continuous porous bodies according to the present embodiment, each weight of the first rotating body 5a and the second rotating body 5b is reduced. Therefore, it is easy to take eccentric balance of the first rotating body 5a and the second rotating body 5b. For example, each weight of the first rotating body 5a and the second rotating body 5b is reduced by using the open-cell structure as the material of the first rotating body 5a and the second rotating body 5b.

Since each weight of the first rotating body 5a and the second rotating body 5b is reduced according to the present embodiment, the first rotating body 5a and the second rotating body 5b can rotate at a high speed. Since the first rotating body 5a and the second rotating body 5b rotate at a high speed, the first rotating body 5a and the second rotating body 5b can be stably rotated even if a load fluctuates.

According to the present embodiment, the axially upper surface 53a of the first rotating body 5a moves air to the radially outer surface 52a side of the first rotating body 5a. Similarly, the axially lower surface 53b of the second rotating body 5b moves air to the radially outer surface 52b side of the second rotating body 5b. Therefore, the amount of air blowing of the centrifugal fan 1 can be increased.

Since the support body 4 has the through-hole 41 according to the present embodiment, the weight of the support body 4 is reduced. Therefore, the first rotating body 5a and the second rotating body 5b can rotate at a high speed. Further, the air having passed through the through-hole 41 is moved to the radially outer surface 52b side of the second rotating body 5b by the second rotating body 5b. Therefore, the air efficiently moves toward the air outlet 22 side.

According to the present embodiment, the open-cell structure can be used as the material of the first rotating body 5a. Since the open-cell structure is a material which is easily processed, it is possible to easily manufacture the first rotating body 5a by using the open-cell structure as the material of the first rotating body 5a. Similarly, the open-cell structure can be used as the material of the second rotating body 5b. Since the open-cell structure is used as the material of the second rotating body 5b, the second rotating body 5b can be easily manufactured.

Since the open-cell structure is used as the material of the first rotating body 5a, the first rotating body 5a can be made soft. When the first rotating body 5a is soft, the housing 2 is hardly damaged even if the first rotating body 5a comes into contact with the housing 2. Therefore, the gap between the first rotating body 5a and the housing 2 becomes narrow by using the open-cell structure as the material of the first rotating body 5a. In other words, the centrifugal fan 1 is downsized. Similarly, since the open-cell structure is used as the material of the second rotating body 5b, the gap between the second rotating body 5b and the housing 2 is narrowed, and the centrifugal fan 1 is downsized.

Next, the first rotating body 5a and the second rotating body 5b according to the first embodiment will be further described with reference to FIG. 4. As illustrated in FIG. 4, the thickness of the first rotating body 5a in the axial direction is equal to the thickness of the second rotating body 5b in the axial direction in the present embodiment. When the thickness of the first rotating body 5a in the axial direction is equal to the thickness of the second rotating body 5b in the axial direction, it is possible to manufacture the first rotating body 5a and the second rotating body 5b, for example, by cutting one type of sheet-like material. Therefore, it is easy to manufacture the first rotating body 5a and the second rotating body 5b.

As illustrated in FIG. 4, an inner diameter of the first rotating body 5a is equal to an inner diameter of the second rotating body 5b, and an outer diameter of the first rotating body 5a is equal to an outer diameter of the second rotating body 5b in the present embodiment. The inner diameter of the first rotating body 5a indicates a distance from the central axis AX to the radially inner surface 51a of the first rotating body 5a. The inner diameter of the second rotating body 5b indicates a distance from the central axis AX to the radially inner surface 51b of the second rotating body 5b. The outer diameter of the first rotating body 5a indicates a distance from the central axis AX to the radially outer surface 52a of the first rotating body 5a. The outer diameter of the second rotating body 5b indicates a distance from the central axis AX to the radially outer surface 52b of the second rotating body 5b.

When the outer diameter of the first rotating body 5a is equal to the outer diameter of the second rotating body 5b, for example, the radially outer surface 52a of the first rotating body 5a and the radially outer surface 52b of the second rotating body 5b can be formed by the same cutting process. As a result, it is easy to manufacture the first rotating body 5a and the second rotating body 5b. Further, when the outer diameter of the first rotating body 5a and the outer diameter of the second rotating body 5b are equal to each other, it is easy to make the central axis of the first rotating body 5a and the central axis of the second rotating body 5b coincide with the central axis AX. Therefore, the work of assembling the centrifugal fan 1 becomes easy. Further, it is easy to design the housing 2 such that a size of the gap between the first rotating body 5a and the housing 2 in the radial direction is the same as a size of the gap between the second rotating body 5b and the housing 2 in the radial direction. Further, it is easy to obtain a high PQ characteristic since the size of the gap between the first rotating body 5a and the housing 2 in the radial direction is the equal to the size of the gap between the second rotating body 5b and the housing 2 in the radial direction.

When the inner diameter of the first rotating body 5a is equal to the inner diameter of the second rotating body 5b, for example, the radially inner surface 51a of the first rotating body 5a and the radially inner surface 51b of the second rotating body 5b can be formed by the same cutting process. As a result, it is easy to manufacture the first rotating body 5a and the second rotating body 5b. Further, when the inner diameter of the first rotating body 5a and the inner diameter of the second rotating body 5b are equal to each other, it is easy to make the central axis of the first rotating body 5a and the central axis of the second rotating body 5b coincide with the central axis AX. Therefore, the work of assembling the centrifugal fan 1 becomes easy.

In the present embodiment, an average pore diameter of the first rotating body 5a is equal to an average pore diameter of the second rotating body 5b. Therefore, the first rotating body 5a and the second rotating body 5b can be manufactured using the same material. Accordingly, it is easy to manufacture the first rotating body 5a and the second rotating body 5b. The average pore diameter is an average of diameters of a plurality of pores of the continuous porous body.

When the thickness, the inner diameter, and the outer diameter of the first rotating body 5a are equal to the thickness, the inner diameter, and the outer diameter of the second rotating body 5b, respectively, and the material of the first rotating body 5a is equal to the material of the second rotating body 5b, It is possible to fix the first rotating body 5a and the second rotating body 5b to the support body 4 without discrimination therebetween. Therefore, the work of fixing the first rotating body 5a and the second rotating body 5b becomes easy.

Incidentally, the average pore diameter of the first rotating body 5a and the average pore diameter of the second rotating body 5b may be different from each other. In other words, the average pore diameter of the first rotating body 5a and the average pore diameter of the second rotating body 5b may be adjusted. For example, it is possible to make the average pore diameter of the first rotating body 5a different from the average pore diameter of the second rotating body 5b by manufacturing the first rotating body 5a and the second rotating body 5b using different materials. The amount of air blowing can be adjusted by adjusting the average pore diameter of the first rotating body 5a and the average pore diameter of the second rotating body 5b. Therefore, it is possible to obtain an optimal PQ characteristic in accordance with a product onto which the centrifugal fan 1 is to be mounted.

It is possible to reduce a force that deforms the support body 4 and the rotor hub 31 in the axial direction by adjusting the average pore diameter of the first rotating body 5a and the average pore diameter of the second rotating body 5b. Specifically, a force that deforms the support body 4 in the axial direction acts on the axially upper surface 42a of the support body 4 from the first rotating body 5a during the rotation of the first rotating body 5a and the second rotating body 5b. On the other hand, a force that deforms the support body 4 in the axial direction acts on the axially lower surface 42b of the support body 4 from the second rotating body 5b. When the force that deforms the support body 4 in the axial direction acts on the support body 4, a force that deforms the rotor hub 31 in the axial direction acts from the support body 4 to the rotor hub 31 since the support body 4 and the rotor hub 31 are fixed. Hereinafter, the force acting on the axially upper surface 42a of the support body 4 from the first rotating body 5a will be referred to as a “first deforming force”, and the force acting on the axially lower surface 42b of the support body 4 from the second rotating body 5b will be referred to as a “second deforming force”. A magnitude of the first deforming force differs depending on the average pore diameter of the first rotating body 5a. A magnitude of the second deforming force differs depending on the average pore diameter of the second rotating body 5b. Therefore, it is possible to control the first deforming force and the second deforming force and to reduce a force that deforms the support body 4 and the rotor hub 31 in the axial direction by adjusting the average pore diameter of the first rotating body 5a and the average pore diameter of the second rotating body 5b.

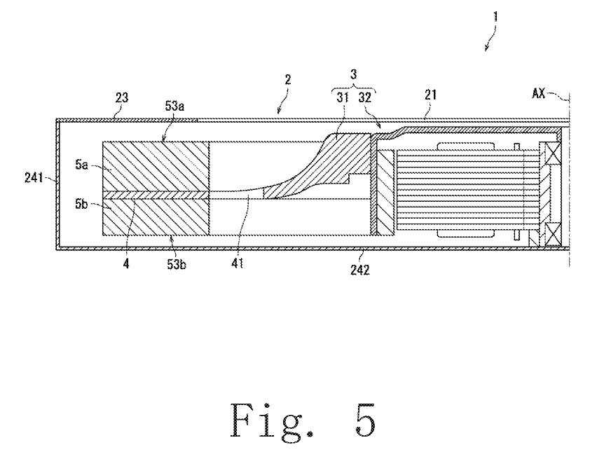

As illustrated in FIG. 5, the thickness of the first rotating body 5a in the axial direction and the thickness of the second rotating body 5b in the axial direction may be different from each other. In other words, the thickness of the first rotating body 5a in the axial direction and the thickness of the second rotating body 5b in the axial direction may be adjusted. FIG. 5 is a view illustrating a first modified example of the first rotating body 5a and the second rotating body 5b according to the first embodiment. In the first modified example, the thickness of the first rotating body 5a in the axial direction is larger than the thickness of the second rotating body 5b in the axial direction. The amount of air blowing can be adjusted by adjusting the thickness of the first rotating body 5a in the axial direction and the thickness of the second rotating body 5b in the axial direction. Therefore, it is possible to obtain an optimal PQ characteristic in accordance with a product onto which the centrifugal fan 1 is to be mounted.

It is possible to reduce a force that deforms the support body 4 and the rotor hub 31 in the axial direction by adjusting the thickness of the first rotating body 5a in the axial direction and the thickness of the second rotating body 5b in the axial direction. Specifically, a magnitude of the first deforming force differs depending on the thickness of the first rotating body 5a in the axial direction. A magnitude of the second deforming force differs depending on the thickness of the second rotating body 5b in the axial direction. Therefore, it is possible to control the first deforming force and the second deforming force and to reduce a force that deforms the support body 4 and the rotor hub 31 in the axial direction by adjusting the thickness of the first rotating body 5a in the axial direction and the thickness of the second rotating body 5b in the axial direction.

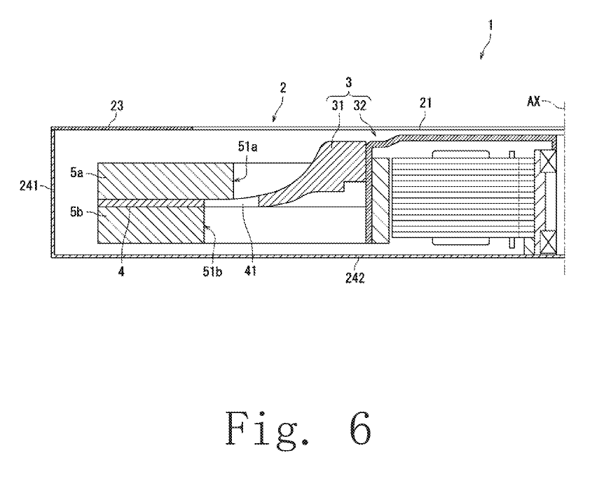

As illustrated in FIG. 6, the inner diameter of the first rotating body 5a and the inner diameter of the second rotating body 5b may be different from each other. In other words, the inner diameter of the first rotating body 5a and the inner diameter of the second rotating body 5b may be adjusted. FIG. 6 is a view illustrating a second modified example of the first rotating body 5a and the second rotating body 5b according to the first embodiment. In the second modified example, the inner diameter of the first rotating body 5a is smaller than the inner diameter of the second rotating body 5b. The amount of air blowing can be adjusted by adjusting the inner diameter of the first rotating body 5a and the inner diameter of the second rotating body 5b. Therefore, it is possible to obtain an optimal PQ characteristic in accordance with a product onto which the centrifugal fan 1 is to be mounted.

It is possible to reduce a force that deforms the support body 4 and the rotor hub 31 in the axial direction by adjusting the inner diameter of the first rotating body 5a and the inner diameter of the second rotating body 5b. Specifically, a magnitude of the first deforming force differs depending on the inner diameter of the first rotating body 5a. A magnitude of the second deforming force differs depending on the inner diameter of the second rotating body 5b. Therefore, it is possible to control the first deforming force and the second deforming force and to reduce a force that deforms the support body 4 and the rotor hub 31 in the axial direction by adjusting the inner diameter of the first rotating body 5a and the inner diameter of the second rotating body 5b.

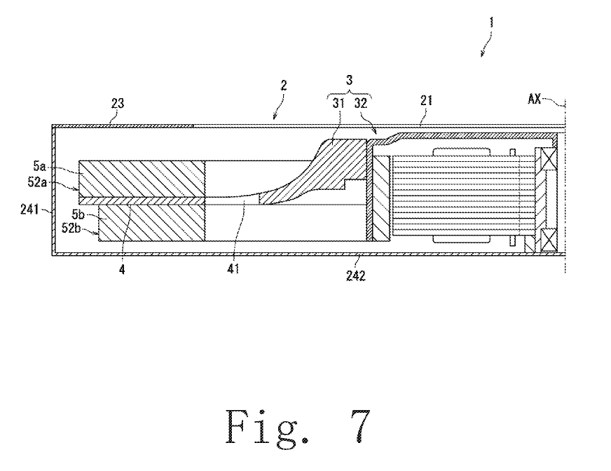

As illustrated in FIG. 7, the outer diameter of the first rotating body 5a and the outer diameter of the second rotating body 5b may be different. In other words, the outer diameter of the first rotating body 5a and the outer diameter of the second rotating body 5b may be adjusted. FIG. 7 is a view illustrating a third modified example of the first rotating body 5a and the second rotating body 5b according to the first embodiment. In the third modified example, the outer diameter of the first rotating body 5a is larger than the outer diameter of the second rotating body 5b. The amount of air blowing can be adjusted by adjusting the outer diameter of the first rotating body 5a and the outer diameter of the second rotating body 5b. Therefore, it is possible to obtain an optimal PQ characteristic in accordance with a product onto which the centrifugal fan 1 is to be mounted.

It is possible to reduce a force that deforms the support body 4 and the rotor hub 31 in the axial direction by adjusting the outer diameter of the first rotating body 5a and the outer diameter of the second rotating body 5b. Specifically, a magnitude of the first deforming force differs depending on the outer diameter of the first rotating body 5a. A magnitude of the second deforming force differs depending on the outer diameter of the second rotating body 5b. Therefore, it is possible to control the first deforming force and the second deforming force and to reduce a force that deforms the support body 4 and the rotor hub 31 in the axial direction by adjusting the outer diameter of the first rotating body 5a and the outer diameter of the second rotating body 5b.

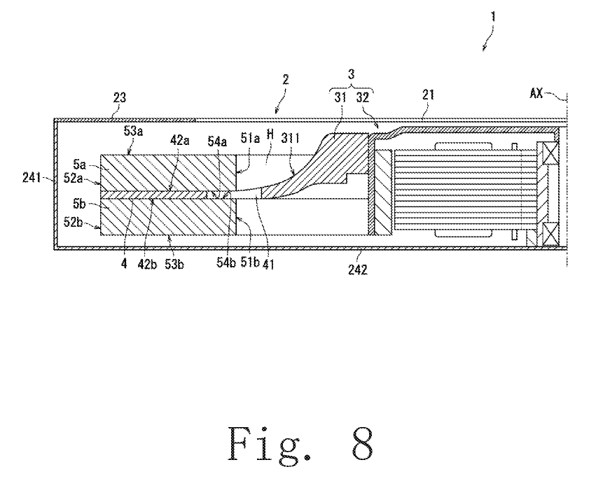

Next, a second embodiment of the present disclosure will be described with reference to FIG. 8. However, items different from those of the first embodiment will be described, and descriptions for the same items as those of the first embodiment will be omitted. The second embodiment is different from the first embodiment in terms of the first rotating body 5a and the second rotating body 5b.

FIG. 8 is a cross-sectional view illustrating a part of the centrifugal fan 1 according to the second embodiment. Specifically, FIG. 8 illustrates cross sections of the housing 2, the motor 3, the support body 4, the first rotating body 5a, and the second rotating body 5b.

As illustrated in FIG. 8, the first rotating body 5a has an axially lower surface 54a, and the second rotating body 5b has an axially upper surface 54b. The axially lower surface 54a of the first rotating body 5a is a surface of the first rotating body 5a on the support body 4 side. The axially upper surface 54b of the second rotating body 5b is a surface of the second rotating body 5b on the support body 4 side.

In the second embodiment, a part of the through-hole 41 overlaps with the first rotating body 5a and the second rotating body 5b in the axial direction. In other words, a part of the through-hole 41 is covered with the axially lower surface 54a of the first rotating body 5a and the axially upper surface 54b of the second rotating body 5b. Therefore, a gap due to the through-hole 41 is formed between the axially lower surface 54a of the first rotating body 5a and the axially upper surface 54b of the second rotating body 5b.

The second embodiment has been described above. According to the second embodiment, air is sucked into the inside of the first rotating body 5a from the axially lower surface 54a of the first rotating body 5a as well as the radially inner surface 51a of the first rotating body 5a. Similarly, air is sucked into the second rotating body 5b from the axially upper surface 54b of the second rotating body 5b as well as the radially inner surface 51b of the second rotating body 5b. Therefore, it is possible to efficiently move the air from the radially inner surface 51a side to the radially outer surface 52a side of the first rotating body 5a and from the radially inner surface 51b side to the radially outer surface 52b side of the second rotating body 5b.

Although a part of each of the through-holes 41 overlaps with the first rotating body 5a and the second rotating body 5b in the axial direction in the present embodiment, the entire part of each of the through-holes 41 may overlap with the first rotating body 5a and the second rotating body 5b.

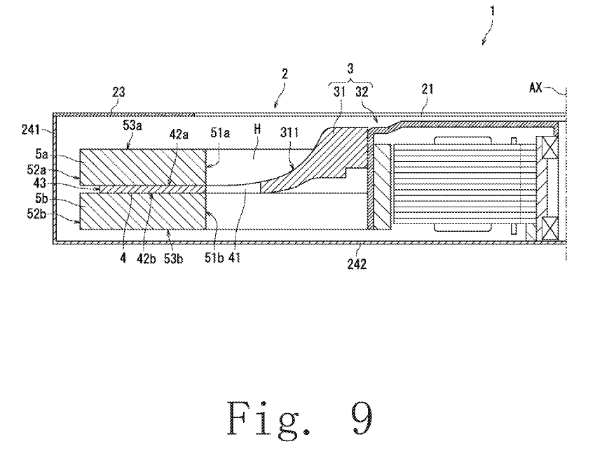

Next, a third embodiment of the present disclosure will be described with reference to FIG. 9. However, items different from those of the first and second embodiments will be described, and descriptions for the same items as those of the first and second embodiments will be omitted. The third embodiment is different from the first and second embodiments in terms of the support body 4.

FIG. 9 is a cross-sectional view illustrating a part of the centrifugal fan 1 according to the third embodiment. Specifically, FIG. 9 illustrates cross sections of the housing 2, the motor 3, the support body 4, the first rotating body 5a, and the second rotating body 5b.

As illustrated in FIG. 9, the support body 4 has a radially outer surface 43. The radially outer surface 43 is an outer-diameter-side distal end surface of the support body 4. In the third embodiment, an outer diameter of the first rotating body 5a and an outer diameter of the second rotating body 5b are larger than an outer diameter of the support body 4. The outer diameter of the support body 4 indicates a distance from the central axis AX to the radially outer surface 43 of the support body 4.

The third embodiment has been described above. The support body 4 is heavier than the first rotating body 5a and the second rotating body 5b. According to the third embodiment, it is possible to reduce the outer diameter of the support body 4. Therefore, it is possible to reduce inertia.

Although the case where the outer diameter of the first rotating body 5a and the outer diameter of the second rotating body 5b are larger than the outer diameter of the support body 4 has been described in the present embodiment, one of the outer diameter of the first rotating body 5a and the outer diameter of the second rotating body 5b may be larger than the outer diameter of the support body 4.

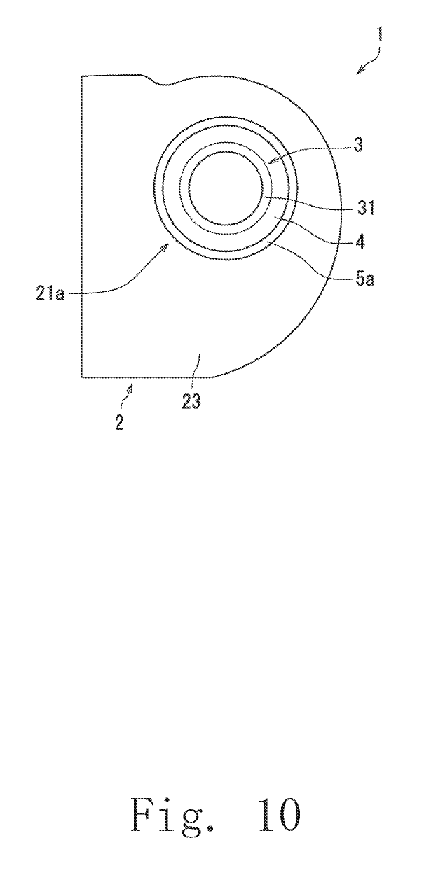

Next, a fourth embodiment of the present disclosure will be described with reference to FIGS. 10 to 12. However, items different from those of the first to third embodiments will be described, and descriptions for the same items as those of the first to third embodiments will be omitted. The fourth embodiment is different from the first to third embodiments in terms of the lower wall portion 242.

FIG. 10 is a plan view illustrating the centrifugal fan 1 according to the fourth embodiment. As illustrated in FIG. 10, the cover member 23 of the housing 2 according to the fourth embodiment has a first air inlet 21a that is open in the axial direction.

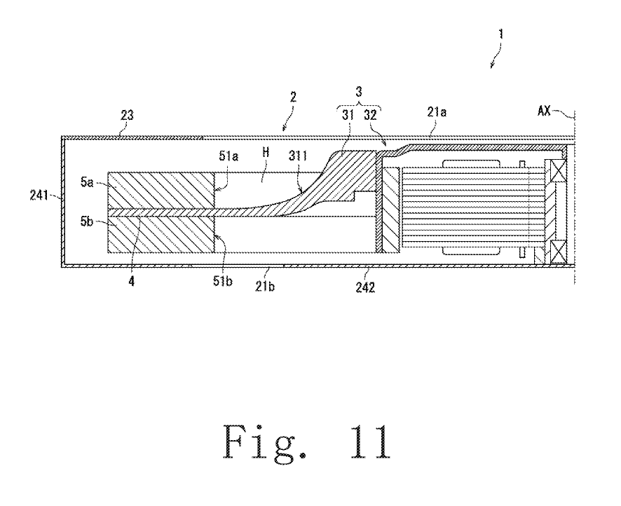

FIG. 11 is a cross-sectional view illustrating a part of the centrifugal fan 1 according to the fourth embodiment. Specifically, FIG. 11 illustrates cross sections of the housing 2, the motor 3, the support body 4, the first rotating body 5a, and the second rotating body 5b. As illustrated in FIG. 11, the lower wall portion 242 of the housing 2 has a second air inlet 21b that is open in the axial direction.

The centrifugal fan 1 according to the fourth embodiment has been described above with reference to FIGS. 10 and 11. According to the fourth embodiment, air is sucked into the inside of the housing 2 from the first air inlet 21a as the first rotating body 5a rotates in the circumferential direction. Further, air is sucked into the inside of the housing 2 from the second air inlet 21b as the second rotating body 5b rotates in the circumferential direction. The air sucked from the first air inlet 21a is sucked into the first rotating body 5a. The air sucked from the second air inlet 21b is sucked into the second rotating body 5b. Therefore, the amount of air blowing can be increased according to the fourth embodiment.

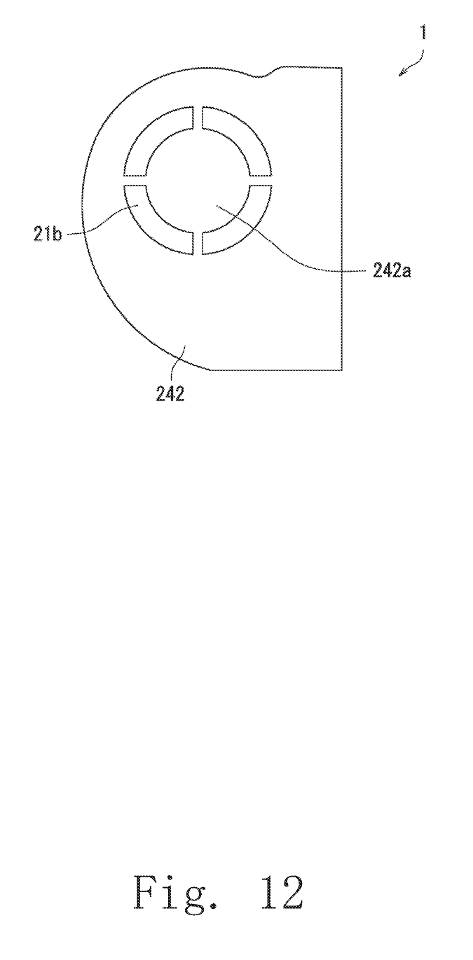

Next, the centrifugal fan 1 according to the fourth embodiment will be described further with reference to FIGS. 10 to 12. FIG. 12 is a bottom view illustrating the centrifugal fan 1 according to the fourth embodiment.

As illustrated in FIG. 12, the lower wall portion 242 has a motor support portion 242a. The motor support portion 242a supports the motor 3 illustrated in FIG. 10. Since the motor support portion 242a supports the motor 3, it is possible to stabilize a distance between the second rotating body 5b and the lower wall portion 242 illustrated in FIG. 11.

As illustrated in FIG. 12, the lower wall portion 242 has a plurality of the second air inlets 21b arranged in the circumferential direction. The plurality of second air inlets 21b surrounds the motor support portion 242a. Since the plurality of second air inlets 21b surrounds the motor support portion 242a, at least some of the second air inlets 21b are arranged to be open on the central axis AX side of the radially inner surface 51b of the second rotating body 5b as illustrated in FIG. 11. Therefore, air can be efficiently sucked into the housing 2. As a result, the amount of air blowing can be increased.

Although the lower wall portion 242 has the plurality of second air inlets 21b in the present embodiment, the lower wall portion 242 may have the single second air inlet 21b.

Although the support body 4 does not have the through-hole 41, which has been described with reference to the first embodiment, in the present embodiment as illustrated in FIGS. 10 and 11, the support body 4 may have the through-hole 41. Since the support body 4 has the through-hole 41, it is possible to reduce the weight of the support body 4.

The first to fourth embodiments of the present disclosure have been described above with reference to the drawings. However, the present disclosure is not limited to the above-described embodiments, and can be implemented in various modes without departing from a gist thereof.

For example, the housing 2 has the single air outlet 22 in the first to fourth embodiments of the present disclosure, but the housing 2 may have a plurality of the air outlets 22.

The present disclosure is suitably applicable to, for example, a centrifugal fan.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A centrifugal fan comprising:
a motor including a rotor hub rotatable about a central axis extending up and down;
a support body fixed to the rotor hub and rotatable together with the rotor hub;
a first rotating body and a second rotating body made of materials different from a material of the support body and defined by continuous porous bodies; and
a housing to house the first rotating body, the second rotating body, the support body, and the motor; wherein
the housing includes a first air inlet open in an axial direction and at least one air outlet open in a radial direction;
the first rotating body is located on a surface of the support body on an axially upper side;
a radially inner surface of the first rotating body opposes a radially outer surface of the rotor hub with a gap interposed therebetween; and
the second rotating body is located on a surface of the support body on an axially lower side.

2. The centrifugal fan according to claim 1, wherein
the support body includes a plurality of through-holes penetrating in the axial direction; and
at least one of the plurality of through-holes includes at least a portion open in the gap between the radially inner surface of the first rotating body and the radially outer surface of the rotor hub.

3. The centrifugal fan according to claim 2, wherein at least one of the plurality of through-holes includes at least a portion overlapping with the first rotating body and the second rotating body in the axial direction.

4. The centrifugal fan according to claim 1, wherein a thickness of the first rotating body in the axial direction is equal to a thickness of the second rotating body in the axial direction.

5. The centrifugal fan according to claim 1, wherein a thickness of the first rotating body in the axial direction is different from a thickness of the second rotating body in the axial direction.

6. The centrifugal fan according to claim 1, wherein an outer diameter of the first rotating body is equal to an outer diameter of the second rotating body.

7. The centrifugal fan according to claim 1, wherein an outer diameter of the first rotating body is different from an outer diameter of the second rotating body.

8. The centrifugal fan according to claim 1, wherein an inner diameter of the first rotating body is equal to an inner diameter of the second rotating body.

9. The centrifugal fan according to claim 1, wherein an inner diameter of the first rotating body is different from an inner diameter of the second rotating body.

10. The centrifugal fan according to claim 1, wherein an average pore diameter of the first rotating body is equal to an average pore diameter of the second rotating body.

11. The centrifugal fan according to claim 1, wherein an average pore diameter of the first rotating body is different from an average pore diameter of the second rotating body.

12. The centrifugal fan according to claim 1, wherein an outer diameter of at least one of the first rotating body and the second rotating body is larger than an outer diameter of the support body.

13. The centrifugal fan according to claim 1, wherein
the housing includes an upper wall portion and a lower wall portion opposing each other in the axial direction;
the upper wall portion includes the first air inlet; and
the lower wall portion includes a second air inlet open in the axial direction.

14. The centrifugal fan according to claim 13, wherein the lower wall portion includes a motor support portion supporting the motor.

15. The centrifugal fan according to claim 14, wherein
the lower wall portion includes a plurality of the second air inlets arranged in a circumferential direction; and
the plurality of second air inlets surrounds the motor support portion.

16. The centrifugal fan according to claim 1, wherein at least one of the first rotating body and the second rotating body includes an open-cell structure.
